(19) United States
(12) Patent Application Publication
(10) Pub. No.: US 2024/0117905 A1
(43) Pub. Date: Apr. 11, 2024

(54) Wide Range Coupling Assembly

(71) Applicant: The Ford Meter Box Company, Inc., Wabash, IN (US)

(72) Inventor: Robert W. Huddleston, Twelve Mile, IN (US)

(21) Appl. No.: 18/482,977

(22) Filed: Oct. 9, 2023

Related U.S. Application Data
(60) Provisional application No. 63/379,065, filed on Oct. 11, 2022.

(51) Int. Cl. F16L 25/14; F16L 19/02; F16L 19/065; F16L 19/07

(52) U.S. Cl. CPC F16L 25/14; F16L 19/0218; F16L 19/065; F16L 19/07

(57) ABSTRACT

A wide range coupling assembly is provided. The wide range coupling assembly includes a coupling body, a first wedge ring, and a second wedge ring. The coupling body has a first open end and a second open end located opposite the first open end. The coupling body is configured to receive a first pipe end in the first open end and a second pipe end in the second open end. The first open end and the second open end of the coupling body are in fluid communication with each other. The first wedge ring is concentrically formed and fitted within the first open end of the coupling body. The second wedge ring is concentrically formed and fitted within the second open end of the coupling body. The first and second wedge rings each include a plurality of spaced apart fingers and a concentric base.

### RELATED APPLICATIONS

The present application relates to and claims priority to U.S. Provisional Patent Application, Ser. No. 63/379,065, filed on Oct. 11, 2022. The subject matter disclosed in that Provisional Application is hereby expressly incorporated into the present application.

### TECHNICAL FIELD AND SUMMARY

The present disclosure relates to water works pipe couplings, and, in particular, to a pipe coupling that can fluidly connect pipes, each having different outside diameters.

Water works pipes, whether in the ground or in a structure, are ubiquitous. Such pipes distribute water or other fluids to any multitude of locations. These pipes are made from any myriad of materials such as copper, PVC, steel, as well as a variety of other plastics and metals. Additionally, these pipes come in an even wider range of diameters, particularly outside diameters.

An issue that can arise with all of these different pipes is that there may be a need to join together two pipes that are in close proximity to each other. In some instances, the pipes that need to be joined together may have different outside diameters.

An illustrative embodiment of the present disclosure provides a wide range coupling assembly. The wide range coupling assembly is configured to join pipes of differing outside diameters together and in fluid communication with each other. The wide range coupling assembly includes a coupling body, a first wedge ring, and a second wedge ring. The coupling body includes a first open end and a second open end located opposite the first open end. The coupling body is configured to receive a first pipe end in the first open end and a second pipe end in the second open end. In addition, the first open end and the second open end of the coupling body are in fluid communication with each other. The first wedge ring is concentrically formed and fitted within the first open end of the coupling body. The second wedge ring is likewise concentrically formed and fitted within the second open end of the coupling body. Each of the first and second wedge rings each include a plurality of spaced apart fingers. The first and second wedge rings each include a concentric base. Each finger of the plurality of fingers extends laterally from the concentric base and into the coupling body such that the plurality of fingers are collectively configured to concentrically surround a pipe located within the coupling body. The concentric base and the plurality of fingers form a space therein configured to receive the pipe. The each finger of the plurality of fingers includes a tip extending therefrom. The tip is directed inwardly towards the space and configured to engage the pipe. The each finger of the plurality of fingers is independently movable with respect to the concentric base.

In the above and other embodiments, the wide range coupling assembly may further provide: an interior of the coupling body includes a first sloped surface formed concentrically about a periphery of the interior and a second sloped surface formed concentrically about the periphery of the interior, wherein the first sloped surface is located adjacent the first open end and having a slope inwardly directed toward a center of the coupling body, and wherein the second sloped surface is located adjacent the second open end and having a slope inwardly directed toward the center of the coupling body; the interior of the coupling body includes a stop tab formed concentrically about a periphery of an interior of the coupling body, wherein the stop tab is located between the first open end and the second open end; a first O-ring located adjacent the first wedge ring and second O-ring located adjacent the second wedge ring; a first coupling nut with an opening disposed therethrough and a threaded inner periphery configured to thread onto corresponding first threads located on an outer periphery of the coupling body adjacent the first open end and a second coupling nut with an opening disposed therethrough and a threaded inner periphery configured to thread onto corresponding second threads located on the outer periphery of the coupling body adjacent the second open end; the first coupling nut is engageable with the first wedge ring to move the first wedge ring into the first open end and further into the coupling body, and the second coupling nut is engageable with the second wedge ring to move the second wedge ring into the second open and further into the coupling body; the first coupling nut moves the first wedge ring against the first sloped surface such that the plurality of fingers engage the first sloped surface so that each tip on the each finger of the plurality of fingers moves further into the space formed by the concentric base and the plurality of fingers of the first wedge ring and the second coupling nut moves the second wedge ring against the second sloped surface such that the plurality of fingers engage the second sloped surface so that each tip on the each finger of the plurality of fingers moves further into the space formed by the concentric base and the plurality of fingers of the second wedge ring; rotation of the first coupling nut translates into linear movement of the first wedge ring and rotation of the second coupling nut translates into linear movement of the second wedge ring; the tip is configured to engage an outer surface of the pipe; and further the first coupling nut moves the first wedge ring into the coupling body a smaller an outer diameter of pipe is securable in the coupling body and less the first coupling nut moves the first wedge ring into the coupling body a larger an outer diameter of pipe is securable in the coupling body, and further the second coupling nut moves the second wedge ring into the coupling body the smaller outer diameter of pipe is securable in the coupling body and less the second coupling nut moves the second wedge ring into the coupling body the larger outer diameter of pipe is securable in the coupling body.

Another illustrative embodiment of the present disclosure provides a wide range coupling assembly. The wide range coupling assembly includes a coupling body, a first wedge ring, and a second wedge ring. The coupling body has a first open end and a second open end located opposite the first open end. The coupling body is configured to receive a first pipe end in the first open end and a second pipe end in the second open end. The first open end and the second open end of the coupling body are in fluid communication with each other. The first wedge ring is concentrically formed and fitted within the first open end of the coupling body. The second wedge ring is concentrically formed and fitted within the second open end of the coupling body. The first and second wedge rings each include a plurality of spaced apart fingers. The first and second wedge rings also each include a concentric base. Each finger of the plurality of fingers extends laterally from the concentric base and into the coupling body such that the plurality of fingers are collectively configured to concentrically surround a pipe located within the coupling body. The concentric base and the plurality of fingers form a space therein configured to receive the pipe.

In the above and other embodiments, the wide range coupling assembly may further provide: each finger of the plurality of fingers includes a tip extending therefrom; the tip is directed inwardly towards the space and configured to engage the pipe; each finger of the plurality of fingers is independently movable with respect to the concentric base; an interior of the coupling body includes a first sloped surface formed concentrically about a periphery of the interior and a second sloped surface formed concentrically about the periphery of the interior, wherein the first sloped surface is located adjacent the first open end and having a slope inwardly directed toward a center of the coupling body, and wherein the second sloped surface is located adjacent the second open end and having a slope inwardly directed toward the center of the coupling body; the interior of the coupling body includes a stop tab formed concentrically about a periphery of an interior of the coupling body, wherein the stop tab is located between the first open end and the second open end; a first O-ring located adjacent the first wedge ring and second O-ring located adjacent the second wedge ring; a first coupling nut with an opening disposed therethrough and a threaded inner periphery configured to thread onto corresponding first threads located on an outer periphery of the coupling body adjacent the first open end and a second coupling nut with an opening disposed therethrough and a threaded inner periphery configured to thread onto corresponding second threads located on the outer periphery of the coupling body adjacent the second open end; and the first coupling nut is engageable with the first wedge ring to move the first wedge ring into the first open end and further into the coupling body and the second coupling nut is engageable with the second wedge ring to move the second wedge ring into the second open end and further into the coupling body.

Additional features and advantages of the wide range coupling will become apparent to those skilled in the art upon consideration of the following detailed descriptions of carrying out the wide range coupling as presently perceived.

### BRIEF DESCRIPTION OF THE DRAWINGS

The concepts described in the present disclosure are illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels may be repeated among the figures to indicate corresponding or analogous elements.

FIG. 1 is a side elevational view of a wide range coupling assembly;

FIG. 2 is an elevational side view of the wide range coupling assembly with two pipes of different outer diameter coupled together;

FIG. 3 is an exploded view of wide range coupling assembly;

FIG. 4A is a perspective side view of the wedge ring;

FIG. 4B is a perspective front view of the wedge ring;

FIG. 4C is a perspective rear view of the wedge ring;

FIG. 4D is a top view of the wedge ring;

FIG. 4E is a side view of the wedge ring;

FIG. 5 is a side elevational cross-sectional view of the wide range coupling assembly;

FIG. 6 is a side elevational view of the wide range coupling assembly with opposing pipes extending from opposing sides;

FIG. 7 is a side elevational cross-sectional view of the wide range coupling assembly with opposing pipes extending from opposing sides;

FIG. 8 is another elevational side cross-sectional view of the wide range coupling assembly;

FIG. 9 is an exploded view of another illustrative embodiment of a wide range coupling assembly; and

FIG. 10 is a side elevational cross-sectional view of the wide range coupling assembly of FIG. 9.

Corresponding reference characters indicate corresponding parts throughout the several views. The exemplification set out herein illustrates embodiments of the wide range coupling, and such exemplification is not to be construed as limiting the scope of the wide range coupling, in any manner.

### DETAILED DESCRIPTION OF THE DRAWINGS

The figures and descriptions provided herein may have been simplified to illustrate aspects that are relevant for a clear understanding of the herein described devices, systems, and methods, while eliminating, for the purpose of clarity, other aspects that may be found in typical devices, systems, and methods. Those of ordinary skill may recognize that other elements and/or operations may be desirable and/or necessary to implement the devices, systems, and methods described herein. Because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

An illustrative embodiment of the present disclosure provides a coupling assembly that can join two pipes together in fluid communication with each other. Specifically, the coupling assembly may join two pipes together that each have different outside diameters while still providing fluid communication between the two.

In an illustrative embodiment, the coupling assembly may include a coupling body having opposing openings—one on each side. The coupling body is configured to house the openings of opposing pipe ends of multiple pipes that are to be coupled together. The pipe openings are fitted in the coupling body so the pipe openings are directed toward each other. Concentrically surrounding each pipe end and fitted in each opposing opening of the coupling body is a wedge ring. Each of these openings receives at least a portion of a wedge ring. Each wedge ring includes a plurality of spaced apart fingers. Each of the fingers extends laterally from a concentric base in about the same longitudinal direction as the pipe that the wedge ring concentrically surrounds. Tips extend from the fingers inwardly towards each other, and, thus, the pipe. Each of the fingers is independently movable against the outer surface of the pipe. Each tip of each finger will engage the outer surface of the pipe when a force is acted on the finger towards the pipe.

Each side of the interior of the coupling body adjacent each opening of same includes a sloped surface concentrically surrounding the interior periphery of the coupling body between a stop tab and the opening. The stop tab defines an opening within the coupling body to help create a passageway through the coupling body from opening to opposed opening. An O-ring may be positioned adjacent the end of each finger of the wedge ring, concentrically surrounding the pipe and abutting a portion of the sloped surface to create a seal between the pipe end and the opening of the coupling body. With these structures fitted on each side of the coupling body, fluid does not escape between each pipe and the coupling body. Instead, the fluid only flows from one pipe end to the other pipe end.

A coupling nut with an opening disposed therethrough, and an illustrative threaded inner periphery, is configured to couple to corresponding threads located on the outer periphery of the coupling body adjacent its opening. A coupling nut is located adjacent each opening of the coupling body. As the coupling nut is rotatingly threaded onto the coupling body, the coupling nut moves linearly and inwardly towards the coupling body. This moves the wedge ring in the direction towards the center of the coupling body as well. The sloped surface of the interior of the coupling body causes the wedge ring to be moved towards the outer surface of the pipe wall, applying a gripping force against same, to hold it in position. The extent to which the coupling nut is movable onto the coupling body and toward its center is dependent on the outside diameter of the pipe. For example, when coupling a pipe with a relatively smaller outside diameter, the coupling nut will move further onto the coupling body. Conversely, when the pipe has a relatively larger outside diameter, the coupling nut will not move further onto the coupling body. This is because the fingers of the wedge ring move further inwardly towards the outside diameter of the outer surface of the pipe to engage same when that outside diameter is smaller as compared to a pipe with the larger outside diameter. To that end, each opposing coupling nut may be independently threaded onto the coupling body to the extent it causes the wedge ring to engage and hold the pipe regardless of its outside diameter and the outside diameter of the opposing pipe.

A method of fluidly coupling adjacent pipes of different outside diameters includes inserting the end of a first pipe into the coupling body and through the wedge ring, O-ring, and coupling nut. Illustratively, the first pipe can extend into the coupling body until it abuts the stop tab. The inner threaded periphery of the coupling nut threads onto the corresponding threads on the outer periphery of the coupling body adjacent its opening. The coupling nut is continued to move in the direction towards the center of the coupling body pushing the wedge ring in the same direction until the tips of the fingers of the wedge ring are moved against the outer surface of the pipe and hold the same in place. With the O-ring located between the wedge ring and the stop tab, as well as against the outer surface of the pipe and the sloped surface of inner periphery of the coupling body, the seal is created between the outer surface adjacent end of the pipe and the opening in the coupling body the pipe is inserted into. This same process is repeated with a second pipe inserted into the opposing side of the coupling body with its own wedge ring, O-ring, and coupling nut. Here, the second pipe may have the same outside diameter as the first pipe or an outside diameter that is larger or smaller. It does not matter. When both opposing pipes are secured to the coupling assembly, only the opening at the stop tab within the coupling body provides fluid communication between the first pipe and the second pipe—completing the fluid connection between the two.

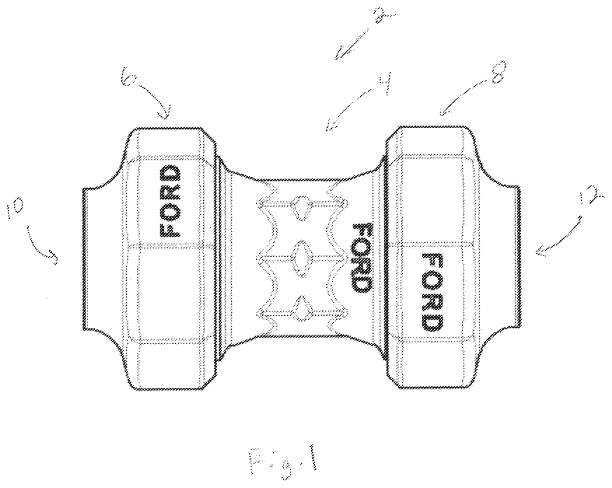

A side elevational view of a wide range coupling assembly 2 is shown in FIG. 1. As depicted, wide range coupling assembly 2 includes a coupling body 4 bounded by coupling nuts 6 and 8 located opposite each other. It is contemplated that one pipe may enter coupling assembly 2 at opening side 10 while a second pipe may enter coupling assembly 2 at opening side 12. In this illustrative embodiment, opening side 10 is actually opposed to opening side 12. It is appreciated, however, that such coupling configuration can be made where the two pipes to be connected may be at different angles (i.e., not necessarily coaxial) with respect to each other. For example, the coupling assembly 2 may include an elbow so that a second pipe may be inserted into coupling assembly 2 at an angle transverse to the angle the first pipe is inserted into coupling assembly 2. For demonstrable purposes, however, axial alignment of the pipes entering coupling assembly 2 is illustrative to help understand the operation and elements of the disclosure. It will be appreciated by the skilled artisan upon reading this disclosure that the arrangement of the openings, coupling nuts, etc. related to this disclosure do not necessarily have to be coaxial with each other.

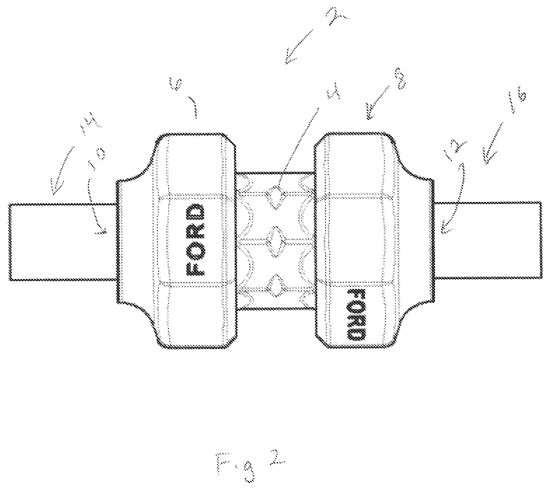

An elevational side view of wide range coupling assembly 2, like that shown in FIG. 1, is shown in FIG. 2. A distinction here is that illustrative opposing pipes 14 and 16 are shown inserted into opening sides 10 and 12 of coupling body 4, respectively. It is appreciable from this view how two pipes can be coupled together to create a continuous flow path of fluid from one pipe (either pipe 14 or 16), through coupling body 4, and to the other pipe (either pipe 16 or 14). In this way, pipes can be fluidly connected with each other. Further, it is appreciated that opening side 12 does not need to be coaxial with opening side 10. Still further, in this illustration, both pipes 14 and 16 have about the same outside diameter. It is appreciated, however, that the outside diameters of fluidly coupled pipes, as shown here, are not required to have the same outside diameter. It is appreciated that a pipe on one side of coupling body 4 may be of a greater or smaller diameter than that of pipe 16 on the opposing side of coupling body 4. It is further appreciated that a utility of the coupling nuts 6 and 8 are to ensure pipes 10 and 16 are secured, respectively, to coupling assembly 2.

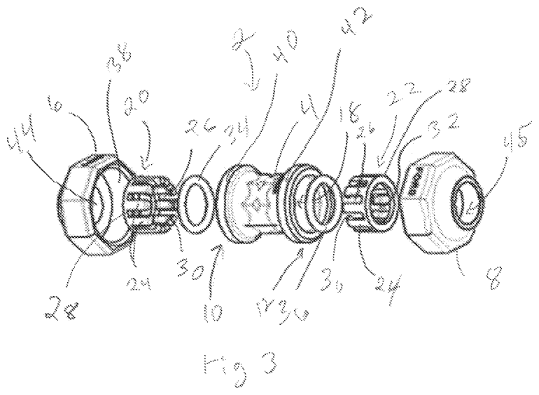

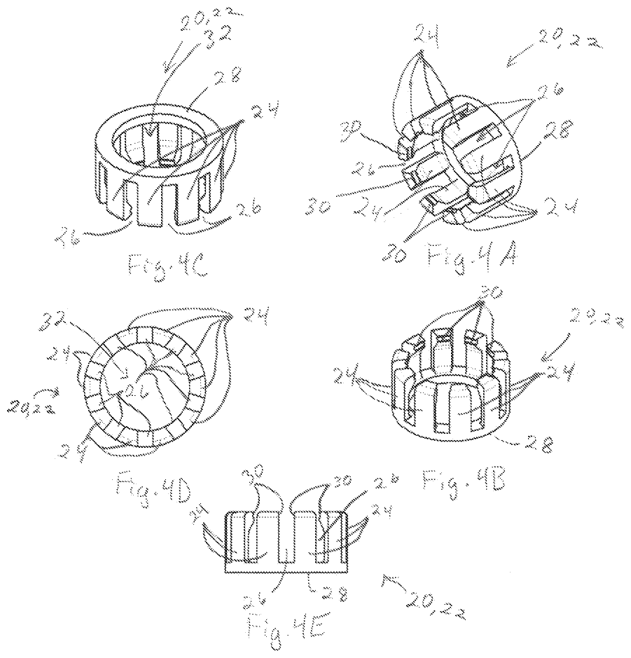

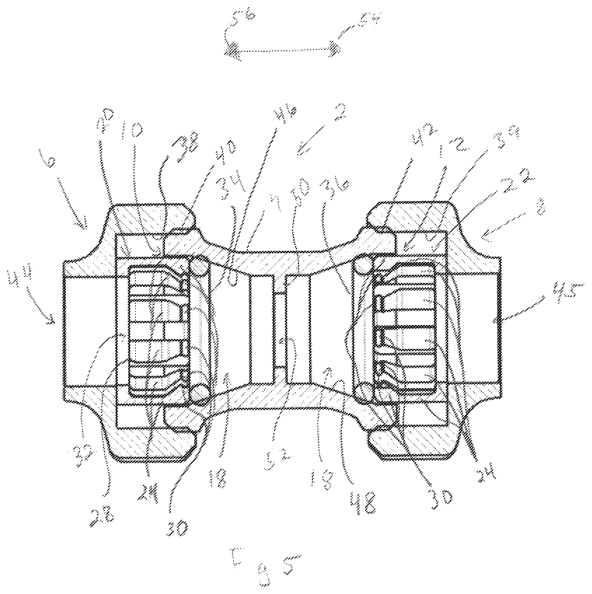

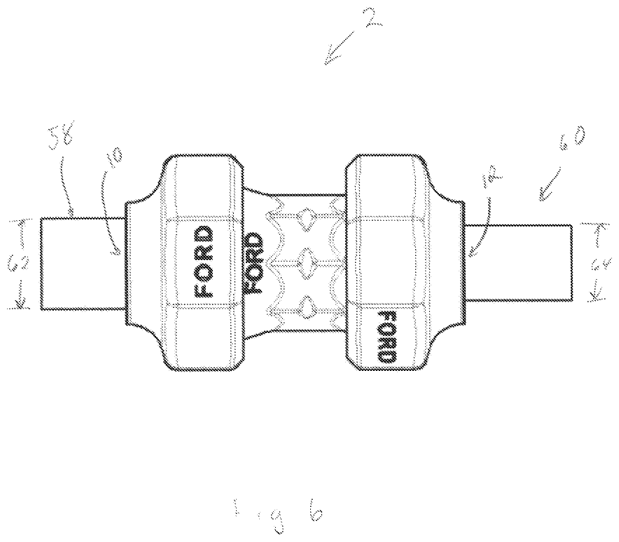

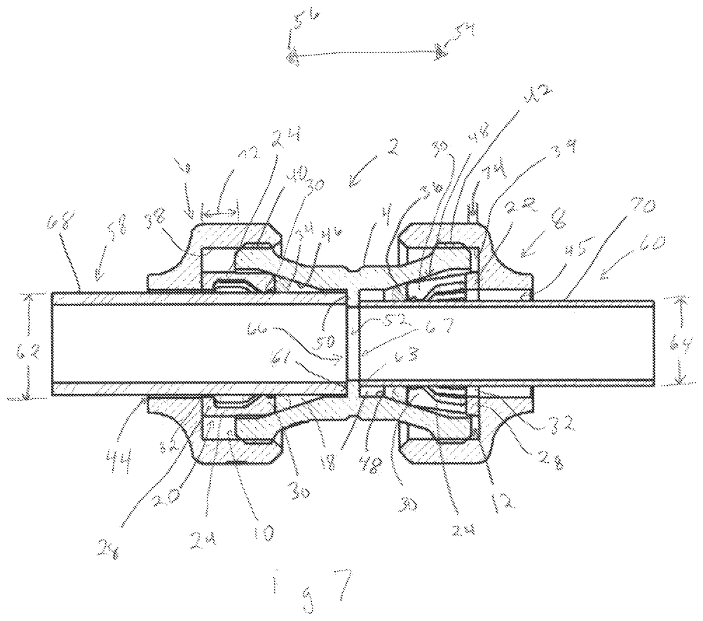

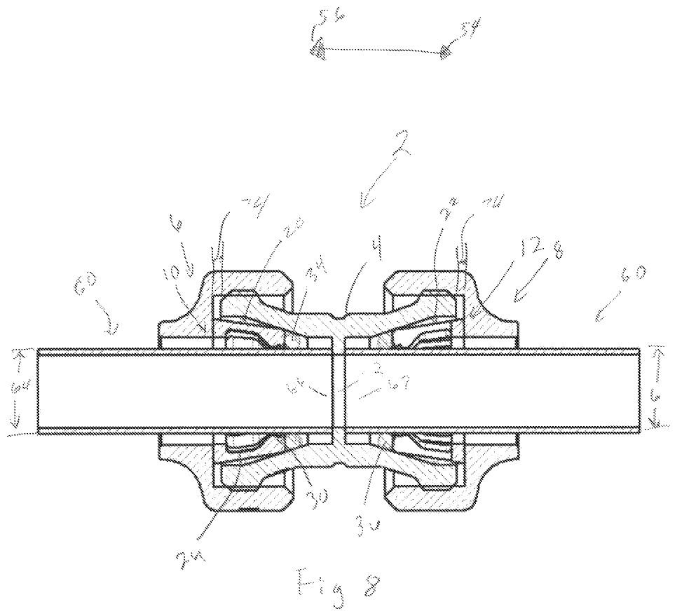

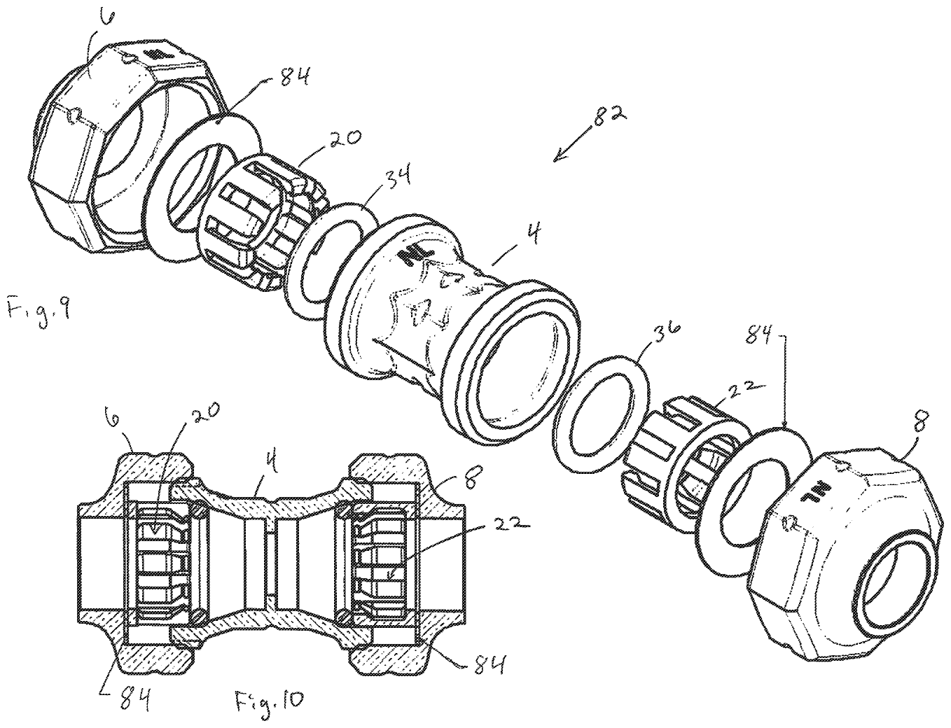

An exploded view of wide range coupling assembly 2 is shown in FIG. 3. Coupling body 4 is shown having a passageway 18 disposed therethrough. Such passageway 18 extends from one side of coupling body 4 to the other. On each side of coupling body 4 is a wedge ring 20 and 22, respectively. Each of wedge rings 20 and 22 includes a plurality of concentrically positioned fingers 24 with a space 26 located therebetween. Each finger 24 extends from a concentric base 28 and illustratively extends longitudinally along the longitudinal extent similar to the direction a pipe will be inserted into the opening sides of the coupling assembly. A tip 30 extends from finger 24 illustratively transverse to the longitudinal extent of same. Additionally, tip 30 extends inwardly towards the center of passageway 18 of coupling body 4. The inner periphery of concentric base 28 forms an opening 32 disposed therethrough in order to receive a pipe that is being inserted into passageway 18. It is appreciated that the plurality of fingers 30 are independently movable with respect to concentric base 28 so that they can apply a force against the outer surface of the pipe. With the fingers 24 positioned in a concentric arrangement around the outer surface of the pipe (see, also, FIGS. 4A-4E and FIG. 5), forces can be applied around the outer surface of the pipe to apply a generally evenly distributed holding force onto the pipe inserted therethrough. An O-ring 34 and 36 are each disposed in passageway 18 of coupling body 4, adjacent respective wedge rings 20 and 22, respectively. Each of coupling nuts 6 and 8, respectively, include a threaded inner periphery 38 that rotatably engages corresponding threaded peripheries 40 and 42 form the outer periphery of opposing sides of coupling body 4 as illustratively shown. Each of coupling nut 6 and 8 include an opening 44 and 45, respectively. Each of openings 44 and 45 are coaxially aligned with openings 32 in wedge rings 20 and 22, respectively, O-ring 34 and 36, respectively, within passageway 18 of coupling body 4. In this way, a pipe may be inserted through opening side 10, opening 44 of coupling nut 6, opening 32 of wedge ring 20, O-ring 34, and passageway 18. Conversely, a second pipe may be inserted through opening 45 of coupling nut 8, opening 32 of wedge ring 22, and O-ring 36 within passageway 18. Thus, with a pipe inserted in each opening side 10 and 12, respectively, of coupling body 4, disconnected pipes can be fluidly connected together.

Various views of wedge ring 20 or 22 are shown in FIGS. 4A, 4B, 4C, 4D, and 4E. The side perspective view of wedge ring 20 or 22 is shown in FIG. 4A. Here, fingers 24 are spaced apart from each other via spaces 26 and extends from concentric base 28. Each of fingers 24 extend longitudinally and transverse to opening 32 (see, also, FIGS. 4C and 4D). Tips 30 extend from each of fingers 24 to provide a gripping surface on the outside surface of a pipe (see, also, FIG. 5, 7, 8) when a pipe is inserted through opening 32. When wedge ring 20 or 22 is fitted into passageway 18 of coupling body 4, the fingers together create a cylindrical—type inner periphery that surrounds the outer surface of the pipe. Each of fingers 24 are movable so they can be moved against the outer surface of the pipe. With tips 30 concentrically positioned about the pipe, they together act as a gripping force on the pipe to hold it in place. It is appreciated that in certain embodiments, wedge ring 20 or 22 is made of a brass material. This affords the fingers a certain level of movability and resiliency so that a pipe can be selectively removed from coupling body 4 and reinserted to be gripped again by wedge ring 20 or 22.

A side elevational cross-sectional view of coupling assembly 2 is shown in FIG. 5. This view depicts how the components of coupling assembly 2, shown in FIG. 3, are coupled together. Passageway 18, adjacent opening side 10 and opening side 12, receive O-rings 34 and 36, respectively. Additionally, a wedge ring 20 is fitted in passageway 18, adjacent O-ring 34, whereas wedge ring 22 is positioned adjacent O-ring 36 in passageway 18. Each side of coupling body 4 includes a conically shaped inner periphery 46 and 48 as illustratively shown. These conically shaped inner peripheries 46 and 48 illustratively oppose each other and are separated by a stop tab 50 extending inwardly toward passageway 18 and separating conically shaped inner periphery 46 from inner periphery 48.

An opening 52, adjacent stop tab 50, fluidly connects the portion of passageway 18 adjacent inner periphery 46 with the portion of passageway 18 at opposed inner periphery 48. The conical shape of these inner peripheries 46 and 48, respectively, are sloped so that as the wedge rings are pushed further toward stop tab 50, fingers 24 are pushed towards the center of passageway 18 to create a smaller opening as needed.

As shown further herein, when a pipe is inserted through opening 44, for example, of coupling nut 6, and inserted through opening 32 in concentric base 28 of wedge ring 20, tips 30 of fingers 24 can bear down on the outer surface of the pipe as coupling nut 6 is moved in direction 54 on coupling body 4. The further coupling nut 6 moves in direction 54, the more the fingers are pushed against the conical shape of inner periphery 46, which pushes fingers 24 inwardly until tips 30 engage the outer surface of the pipe.

In this illustrative embodiment, inner periphery 38 of coupling nut 6 includes threads that correspond to corresponding threaded periphery 40 on coupling body 4. By rotating threads on inner periphery 38, with corresponding threaded periphery 40, coupling nut 6 has the ability to move linearly in either directions 54 or 56. The extent to which coupling nut 6 moves in direction 54 to cause wedge ring 20 to engage a pipe depends on the outer diameter of that pipe.

A smaller outer diameter of the pipe requires coupling nut 6 to move further in direction 54 so the wedge ring can grip the smaller diameter of the pipe. Conversely, for a larger outer diameter of pipe, the coupling nut 6 does not need to move as far in direction 54. It will be appreciated by the skilled artisan upon reading this disclosure that the structures and methods of moving coupling nut 6 in direction 54 to cause wedge ring 20 to engage a pipe can be equally applied to coupling nut 8, in this case positioned opposite coupling nut 6, with the exception that coupling nut 8 will move in direction 56 to move its adjacent wedge ring 22 against conical inner periphery 48 sufficient to grip and hold a pipe inserted through opening 45.

A side elevational view of wide range coupling assembly 2, with opposing pipes 58 and 60 extending from opening sides 10 and 12, respectively, is shown in FIG. 6. This view is distinguishable from the side elevational view of coupling assembly 2 shown in FIG. 2, for example, because in FIG. 6, opposing pipes 58 and 60 each have different outside diameters from each other. As shown, the outside diameter of pipe 58, indicated by dimensional arrows 62 is greater than the outside diameter of pipe 60, as indicated by dimensional arrows 64. Despite these different outside diameters, both pipes 58 and 60 may be fluidly coupled to gather.

A side elevational cross-sectional view of wide-ranging coupling assembly 2 is shown in FIG. 7. Furthering the view in FIG. 6, this view in FIG. 7 demonstrates how coupling assembly 2 works to couple together two separate pipes, each having a different outside diameter. As shown, pipe 58 is shown inserted into opening 44 of coupling nut 6, as well as through opening 32 of wedge ring 20 and into passageway 18 within coupling body 4. Illustratively, end 61 of pipe 58 abuts against stop tab 50 to allow end opening 66 to be included in communication with opening 52 of coupling body 4. Outer surface 68 of pipe 58 engages tip 30 of finger 24 from wedge ring 20.

How wedge ring 20 secures pipe 58 into coupling body 4 is at least a combination of coupling nut 6 and sloped conical inner periphery 46 of the passageway 18 within coupling body 4. With pipe 58 inserted into passageway 18, wedge ring 20 can be moved in direction 54 by rotating coupling nut 6 further onto coupling body 4. When this happens, finger 24 engages the sloped conically-shaped inner periphery 46 such that the further wedge ring 20 is moved in direction 54 the more finger 24 is pushed inwardly within passageway 18. This inward directed movement of finger 24 causes tip 30 to engage outer surface 68 of pipe 58. Because wedge ring 20 illustratively includes a plurality of fingers 24 (see, also, FIGS. 4A-E and 5), all of these fingers will be pushed against outer surface 68 to hold pipe 58 in place within coupling body 4. It will be appreciated by the skilled artisan upon reading this disclosure that the more coupling nut 6 is moved in direction 54, the more force inward against pipe 58 will be applied by finger 24 end tip 30. In instances where the outer diameter 62 of pipe 58 is relatively large, the distance coupling nut 6 must travel in direction 54 in order to secure pipe 58 within coupling body 4, is illustratively shown herein. Dimension 72, which represents the span between the end of coupling body 4 and the inner periphery of coupling nut 6, is relatively large. This indicates that not much of coupling nut 6 needs to be threadingly coupled to coupling body 4 in order to secure pipe 58 with an outer diameter 62, as shown, to secure pipe 58 within coupling body 4.

In contrast, on the other side of coupling body 4 is pipe 60 disposed through opening 45 of coupling nut 8, as well as opening 32 within wedge ring 22 and into passageway 18. End 63 of pipe 60 abuts stop tab 50 of coupling body 4 so that end opening 67 of pipe 60 is adjacent opening 52. The result of this is that pipes 58 and 60 are now in fluid communication with each other, so that fluid within pipe 58 may flow out through end opening 66 across opening 52 and into pipe 60 via end opening 67, as well as the reverse. Coupling nut 8 threadingly couples to and moves along corresponding threaded periphery 42 on coupling body 4 in order to move coupling nut 8 in direction 56. When this happens, coupling nut 8 acts against wedge ring 22 so its fingers are moved against conical inner periphery 48 of passageway 18. The further inward wedge ring 22 is moved in direction 56 by coupling nut 8, through passageway 18, the more fingers 24 are moved. This continues until tips 30 of fingers 24 engage outer surface 70 of pipe 60. Again, because of the plurality of fingers movable concentrically positioned about opening 32, wedge ring 22 grips and holds pipe 60 about the circumference of same. Here, when outer diameter 64 of pipe 60 is less than outer diameter 62 of pipe 58 the distance coupling nut 8 must move in direction 56 is more than what coupling nut 6 needs to move in direction 54 in order to couple pipe 60 within coupling body 4. This is demonstrated by the distance between the end of coupling body 4 and inner periphery 39 of coupling nut 8, as indicated by dimension 74. O-ring 34 is positioned around pipe 58 such that it wedges between inner periphery 46 of passageway 18 of coupling body 4 and outer surface 68 of pipe 58. As is demonstrated herein, with O-ring 34 so positioned, any fluid that exits in end opening 66 is prevented from exiting between outer surface 68 and passageway 18. O-ring 34 blocks any flow path.

Comparing dimension 74 to dimension 72 makes clear that coupling nut 8 is moved onto coupling body 4 more than coupling nut 6 is. This is logical since outer diameter 64 of pipe 60 is less than outer diameter 62 of pipe 58, thereby requiring more movement of fingers 24 and tips 30 inwardly into passageway 18 in order to grip pipe 60. O-ring 36, like that described with respect to O-ring 34, is positioned between inner periphery 48 of passageway 18 of coupling body 4 and outer surface 70 of pipe 60. It is also appreciated that fingers 24 can push O-ring 36 further into passageway 18 as needed to create the seal between inner periphery 48 and outer surface 70 to prevent any fluid from end opening 67 from escaping through passageway 18 between outer surface 70 and inner periphery 48.

Another elevational side cross-sectional view of wide range coupling assembly 2 is shown in FIG. 8. This view is similar to that shown in FIG. 7 except that separate pipe 60, each having the same outer diameter 64, are inserted into each side 10 and 12, respectively, of coupling body 4. This view demonstrates that in this case, both coupling nut 6 and coupling nut 8 will be moved inwardly onto coupling body 4 substantially the same amount as indicated by dimension 74, as indicated therein. Accordingly, any wide range of outer diameters of pipes may be coupled together via coupling assembly 2 regardless whether the pipes have the same outer diameter or different outer diameters.

Another illustrative embodiment of the present disclosure provides a wide range coupling assembly 82. This embodiment is similar to wide range coupling assembly 2 except that assembly 82 includes an anti-friction ring 84 positioned between each of coupling nuts 6/8 and wedge rings 20/22, respectively. Anti-friction rings 84 allow better rotation of respective coupling nuts 6 and 8 when rotated on coupling body 4 for purposes of moving respective wedge rings 20 and 22 inward and outward with respect to coupling body 4.

A side elevational cross-sectional view of the wide range coupling assembly 82 is shown in FIG. 10. This view further demonstrates how anti-friction rings 84 are each positioned between respective coupling nuts 6/8 and wedge rings 20/22. Ease and rotating the coupling nut on coupling body 4 is increased by including antifriction ring 84 between the coupling nut and wedge ring on each side of coupling body 4.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features. It should also be appreciated that any subject matter disclosed in this non-provisional patent application that may differ from the priority application, then the disclosure from this non-provisional patent application controls.

What is claimed:

1. A wide range coupling assembly configured to join pipes of differing outside diameters together and in fluid communication with each other, the wide range coupling assembly comprising:
a coupling body having a first open end and a second open end located opposite the first open end;
wherein the coupling body is configured to receive a first pipe end in the first open end and a second pipe end in the second open end;
wherein the first open end and the second open end of the coupling body are in fluid communication with each other;
a first wedge ring concentrically formed and fitted within the first open end of the coupling body;
a second wedge ring concentrically formed and fitted within the second open end of the coupling body;
wherein each of the first and second wedge rings each include a plurality of spaced apart fingers;
wherein the first and second wedge rings each include a concentric base;
wherein each finger of the plurality of fingers extends laterally from the concentric base and into the coupling body such that the plurality of fingers are collectively configured to concentrically surround a pipe located within the coupling body;
wherein the concentric base and the plurality of fingers form a space therein configured to receive the pipe;
wherein the each finger of the plurality of fingers includes a tip extending therefrom;
wherein the tip is directed inwardly towards the space and configured to engage the pipe; and
wherein the each finger of the plurality of fingers is independently movable with respect to the concentric base.

2. The wide range coupling of claim 1, wherein an interior of the coupling body includes a first sloped surface formed concentrically about a periphery of the interior and a second sloped surface formed concentrically about the periphery of the interior, wherein the first sloped surface is located adjacent the first open end and having a slope inwardly directed toward a center of the coupling body, and wherein the second sloped surface is located adjacent the second open end and having a slope inwardly directed toward the center of the coupling body.

3. The wide range coupling of claim 1, wherein the interior of the coupling body includes a stop tab formed concentrically about a periphery of an interior of the coupling body, wherein the stop tab is located between the first open end and the second open end.

4. The wide range coupling of claim 1, further comprising a first O-ring located adjacent the first wedge ring and second O-ring located adjacent the second wedge ring.

5. The wide range coupling of claim 2, further comprising a first coupling nut with an opening disposed therethrough and a threaded inner periphery configured to thread onto corresponding first threads located on an outer periphery of the coupling body adjacent the first open end and a second coupling nut with an opening disposed therethrough and a threaded inner periphery configured to thread onto corresponding second threads located on the outer periphery of the coupling body adjacent the second open end.

6. The wide range coupling of claim 5, wherein the first coupling nut is engageable with the first wedge ring to move the first wedge ring into the first open and further into the coupling body and the second coupling nut is engageable with the second wedge ring to move the second wedge ring into the second open and further into the coupling body.

7. The wide range coupling of claim 6, wherein the first coupling nut moves the first wedge ring against the first sloped surface such that the plurality of fingers engage the first sloped surface so that each tip on the each finger of the plurality of fingers moves further into the space formed by the concentric base and the plurality of fingers of the first wedge ring and the second coupling nut moves the second wedge ring against the second sloped surface such that the plurality of fingers engage the second sloped surface so that each tip on the each finger of the plurality of fingers moves further into the space formed by the concentric base and the plurality of fingers of the second wedge ring.

8. The wide range coupling of claim 5, wherein rotation of the first coupling nut translates into linear movement of the first wedge ring and rotation of the second coupling nut translates into linear movement of the second wedge ring.

9. The wide range coupling of claim 7, wherein the tip is configured to engage an outer surface of the pipe.

10. The wide range coupling of claim 5, wherein further the first coupling nut moves the first wedge ring into the coupling body a smaller outer diameter of pipe is securable in the coupling body and less the first coupling nut moves the first wedge ring into the coupling body a larger outer diameter of pipe is securable in the coupling body, and further the second coupling nut moves the second wedge ring into the coupling body the smaller outer diameter of pipe is securable in the coupling body and less the second coupling nut moves the second wedge ring into the coupling body the larger outer diameter of pipe is securable in the coupling body.

11. A wide range coupling assembly configured to join pipes of differing outside diameters together and in fluid communication with each other, the wide range coupling assembly comprising:
a coupling body having a first open end and a second open end located opposite the first open end;
wherein the coupling body is configured to receive a first pipe end in the first open end and a second pipe end in the second open end;
wherein the first open end and the second open end of the coupling body are in fluid communication with each other;
a first wedge ring concentrically formed and fitted within the first open end of the coupling body;
a second wedge ring concentrically formed and fitted within the second open end of the coupling body;
wherein the first and second wedge rings each include a plurality of spaced apart fingers;
wherein the first and second wedge rings each include a concentric base;
wherein each finger of the plurality of fingers extends laterally from the concentric base and into the coupling body such that the plurality of fingers are collectively configured to concentrically surround a pipe located within the coupling body; and
wherein the concentric base and the plurality of fingers form a space therein configured to receive the pipe.

12. The wide range coupling of claim 11, wherein the each finger of the plurality of fingers includes a tip extending therefrom.

13. The wide range coupling of claim 12, wherein the tip is directed inwardly towards the space and configured to engage the pipe.

14. The wide range coupling of claim 11, wherein the each finger of the plurality of fingers is independently movable with respect to the concentric base.

15. The wide range coupling of claim 11, wherein an interior of the coupling body includes a first sloped surface formed concentrically about a periphery of the interior and a second sloped surface formed concentrically about the periphery of the interior, wherein the first sloped surface is located adjacent the first open end and having a slope inwardly directed toward a center of the coupling body, and wherein the second sloped surface is located adjacent the second open end and having a slope inwardly directed toward the center of the coupling body.

16. The wide range coupling of claim 11, wherein the interior of the coupling body includes a stop tab formed concentrically about a periphery of an interior of the coupling body, wherein the stop tab is located between the first open end and the second open end.

17. The wide range coupling of claim 11, further comprising a first O-ring located adjacent the first wedge ring and second O-ring located adjacent the second wedge ring.

18. The wide range coupling of claim 15, further comprising a first coupling nut with an opening disposed therethrough and a threaded inner periphery configured to thread onto corresponding first threads located on an outer periphery of the coupling body adjacent the first open end and a second coupling nut with an opening disposed therethrough and a threaded inner periphery configured to thread onto corresponding second threads located on the outer periphery of the coupling body adjacent the second open end.

19. The wide range coupling of claim 18, wherein the first coupling nut is engageable with the first wedge ring to move the first wedge ring into the first open and further into the coupling body and the second coupling nut is engageable with the second wedge ring to move the second wedge ring into the second open and further into the coupling body.
